(19) United States
(12) Patent Application Publication
(10) Pub. No.: US 2015/0066792 A1
(43) Pub. Date: Mar. 5, 2015

(54) MATCHING PROFESSIONAL SERVICE PROVIDERS WITH EMPLOYERS HAVING WORK ASSIGNMENTS

(71) Applicant: Samuel S. SPRAGUE, Melbourne Beach, FL (US)

(72) Inventor: Samuel S. SPRAGUE, Melbourne Beach, FL (US)

(21) Appl. No.: 14/220,817

(22) Filed: Mar. 20, 2014

Related U.S. Application Data
(60) Provisional application No. 61/959,727, filed on Sep. 3, 2013.

(51) Int. Cl. G06Q 10/10

(52) U.S. Cl. CPC G06Q 10/1053
USPC 705/321

(57) ABSTRACT

A method is disclosed for matching service providers with employers who have work assignments. The method is suitable for implementation on an Internet website. The method provides a mechanism for service providers and employers to negotiate the terms on which service providers and employers enter into contract with each other. The identities of a prospective employer and a potentially interested service provider are kept confidential from each other until both are interested in negotiating. Certain information input to the website is verified by the operator of the website in order to weed out persons who misrepresent their credentials or their identities.

### BACKGROUND OF THE INVENTION

The invention relates to methods of matching professional service providers with employers having work assignments. More particularly, the invention relates to methods of this type that are well-adapted for computerization and use on an Internet website. In its most immediate sense, the invention relates to methods of matching medical professionals with healthcare facilities that need their services.

Internet websites are commonly used for matching, and specifically for matching parties who need services with parties who render them. For example, such matching services are available through www.elance.com. All such websites collect information about the parties, permit the information to be searched, and provide a mechanism whereby parties can be matched with each other so that a particular party with a need for work can be matched with a party who can provide that work.

However, there are certain employment markets that require more specialized matching services. One such market is the medical field. When for example a hospital wants to hire an ICU nurse for a few months to cover for an employee who is ill or on leave, the hospital needs to know that applicants for this position do in fact have the appropriate credentials (i.e. have a license to work as a nurse in the state where the job is located and have the necessary certification to work in an ICU). Thus, it is necessary to verify the applicant's credentials by e.g. checking state registries, contacting nursing schools, etc.

Additionally, deception is ubiquitous on the Internet. Employment agencies are known to masquerade as employers and service providers. When an agency masquerades as a service provider on a website, a healthcare facility may contact the “service provider” to inquire about his/her availability and rates. In this way, the agency learns that the healthcare facility has an open position and can try to obtain a search assignment. And, when an agency masquerades as a healthcare facility and receives resumes from applicants, the agency can then try to sell those applicants to other healthcare facilities. In some instances, agencies have released resumes to prospective employers without authorization from the applicants.

Furthermore, there are instances wherein hospitals and nurses require confidentiality. For example, a hospital may wish to discharge a particular ICU nurse but does not want that nurse to know that a replacement is being sought and therefore wants that nurse to be unable to learn of its intention to replace her by searching the Internet and possibly discovering that the hospital has advertised to fill a position that she presently holds. So, too, a nurse may be looking to leave his or her current position but does not want his or her employer to know this and likewise does not want her identity to be revealed by an Internet search.

Additionally, some individuals are concerned about parity in the exchange of information. Such individuals do not wish to identify themselves to an anonymous employer because this provides the employer with an information advantage; the employer knows the applicant's personal information while the applicant knows little about the organization to which he or she has applied.

These reasons motivate both employers and professional service providers to avoid Internet matching websites and instead to engage personnel agencies to carry out this matching function. However, this is a time-consuming task for personnel agencies. Personnel agencies need to charge a substantial commission in order to match a prospective employer with an appropriate professional service provider in an appropriately professional manner. This is unsatisfactory for both the employer and the professional service provider because the commission increases the costs of the employer and decreases the compensation that the employer is willing to pay the professional provider.

These considerations are equally applicable to other professional service providers, e.g. accountants, lawyers, engineers etc.

It would be advantageous to provide a method for matching professional service providers with employers having work assignments, which method could be computerized and implemented on an Internet website and would be suitable for use by professional service providers and employers who require their services.

One object of the invention is to provide a method for matching professional service providers with employers having work assignments that allows a service provider and a potential employer to remain anonymous from each other until they are mutually interested in exploring the possibility of working together.

Another object of the invention is to provide such a method that simultaneously terminates this anonymity for both the service provider and the employer, thereby insuring that both parties are on an equal footing insofar as information is concerned.

Still another object is to provide such a method that gives service providers and employers confidence that they are dealing with genuine parties and not employment agencies that are masquerading as service providers and employers.

Yet a further object is to provide such a method that allows professional service providers to bid for work assignments from prospective employers and that supports negotiations between the service providers and the employers.

These objects, and others that will become apparent below, are achieved by the invention. In accordance with the invention, a method for matching professional service providers with employers having work assignments is provided. Items of information required to be provided by the service providers are established and are categorized as generally available provider information, which includes credentials of the service provider, and restricted provider information, which includes identity of the service provider. And, items of information required to be provided by the employers are established and categorized as generally available employer information and restricted employer information, which includes identity of the employer.

A contract template appropriate for contractually engaging a professional service provider to perform a work assignment for an employer is established. The contract template has legal terms and conditions that cannot be changed by either the employer or the service provider and also has negotiable data items that can be supplied and modified by the employer and the service provider.

A database is created. It includes information about a) service providers who have provided all required items of information and whose credentials and identity have been verified and b) employers who have provided all required items of information and whose identity has been verified.

Initially, in the absence of a bid described below, only the generally available provider information provided by service providers in the database is made available to employers in the database and the restricted provider information provided by service providers in the database is made unavailable to employers in the database. So, too, initially only the generally available employer information provided by employers in the database is made available to service providers in the database and restricted employer information provided by employers in the database is made unavailable to service providers in the database.

A service provider directs a bid to a particular employer by bidding on a job that the employer has posted on the website. The bid includes all negotiable data items in the contract template that are required to be included by the employer and is presented to the employer identified by the bidding service provider. The employer is allowed to open a bid, thereby automatically making the restricted employer information of the employer that opens the sealed bid available to the bidding service provider, and simultaneously with making such restricted employer information available to the bidding service provider, the restricted provider information of the bidding service provider is automatically made available to the employer that opened the bid.

With the possible exception of some or all of the verification processes, the method in accordance with the invention is suitable for computerization and implementation on an Internet website. Thus, the recurring personnel costs associated with practicing the inventive method are substantially less than those required for a conventional personnel agency. This enables a website operator that practices the method on an Internet website to offer matching services at advantageous rates.

Because the credentials of each of the service providers have been verified (“verification” of credentials presently means that an image of a credential-evidencing document has been uploaded to the website and the website operator has determined that the image is consistent with information in corresponding state records, e.g. uploaded images of an ICU nurse's licenses have been found to correspond with information in the state agencies that issued the licenses or an uploaded image of an attorney's certificate of admission to practice corresponds to a state bar list of attorneys who have been admitted to practice in that state, but other means of verification can be used instead or additionally) employers can be assured that the professional service providers are lawfully able to offer their services to them. And, because the identities of all the service providers and all the employers have also been verified, all the service providers and employers can have confidence that they are dealing with parties who are genuinely seeking work or are genuinely seeking professional services. (At present, “verification” of the identity of a service provider is carried out by searching to see if e.g. a person having the name shown on the service provider's uploaded license image is listed as living at the address the service provider inputs to the website. “Verification” of the identity of an employer is carried out by searching on the employer's Employer Identification Number (“EIN”) to determine consistency with information input to the website. However, other means of verification can be used instead or additionally.)

Furthermore, in accordance with the invention, neither party ever has superior information about the other. A service provider who directs a bid to a particular employer knows that his or her identity will not be disclosed to the employer unless and until the employer decides to open the bid. So, too, an employer who opens a bid knows that doing so will reveal the employer's identity to the bidding service provider.

Advantageously, and in accordance with the preferred embodiment of the invention, the required negotiable data items in the service provider's bid can be modified by both the employer and the service provider. Thus, for example, an ICU nurse's bid may propose a particular start date for his or her work, a particular rate of compensation, and a particular pay period (e.g. every week or two weeks). The prospective employer can then modify the negotiable data items by e.g. counter-proposing that the nurse begin and end work at later dates and that compensation be paid thirty days after the nurse submits her invoice for services rendered. In this way, the parties can negotiate with each other.

Further advantageously, and also in accordance with the preferred embodiment, either party can agree to all the negotiable data items proposed or modified by the other party. When this happens, a binding contract is formed between the parties; the legal terms and conditions of the contract are established by the contract template, the negotiated matters (e.g. dates of engagement, compensation, frequency of payment) are established by the agreed-upon negotiable data items, and the parties are established by the identities of the service provider and the employer.

In accordance with the preferred embodiment, verification of the identities of the service providers and of the employers is at least partially carried out manually, i.e. not by computer.

Advantageously, and also in accordance with the preferred embodiment, the method is computerized and implemented on an Internet website, and all generally available information is available to anyone who accesses the website.

### BRIEF DESCRIPTION OF THE DRAWINGS

The invention will be better understood with reference to the following illustrative and non-limiting drawings, in which:

FIG. 1 is a flowchart showing registration of users on a website that implements a method in accordance with the preferred embodiment of the invention; and

FIG. 2 is a flowchart showing how service providers are matched with employers having work assignments when using a website that implements a method in accordance with the preferred embodiment of the invention.

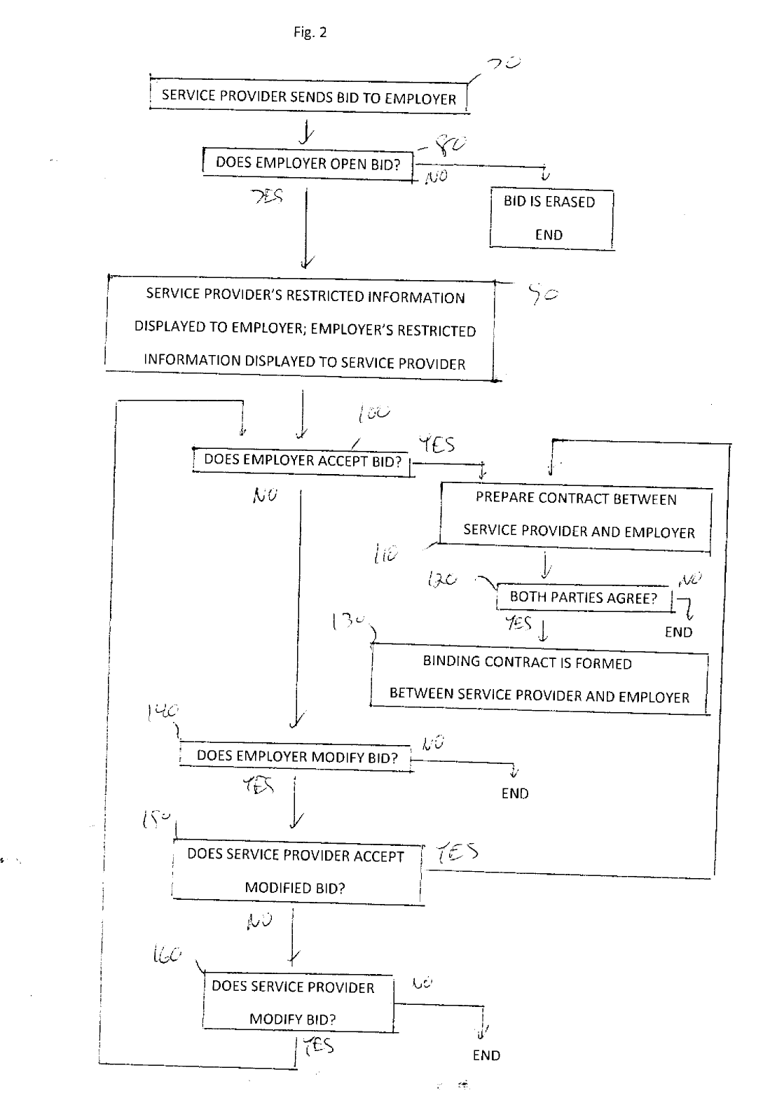

### DETAILED DESCRIPTION OF PREFERRED EMBODIMENTS

The following detailed description proceeds with specific reference to medical personnel and employers that are healthcare facilities. This is merely for ease of illustration. It will be understood that the invention is suitable for use with any licensed professionals, i.e. lawyers, accountants, architects, engineers, etc. Furthermore, although the following description refers to a website that is dedicated exclusively to a single industry (namely the healthcare industry) the invention could equally well be used for more than one industry.

A website in accordance with the preferred embodiment is established with an Internet hosting company. When a member of the public reaches the website, the following information is viewable:

### For Each Medical Professional

1. A summary of the professional's skills;
2. Time frames during which the professional is available to work;
3. Highest degree achieved; and
4. A verification that the professional has an active and clear (i.e. unrestricted) license for his/her discipline, and the states in which this is so.

### For Each Posted Work Assignment

1. The title of the job;
2. The discipline/license type required;
3. The city and state where the job is located;
4. The type (e.g. hospital, physician's office) of facility in which the work will be done;
5. The duration of the job;
6. The desired start date;
7. The job type (full-time, part-time, as-needed);
8. Minimum guaranteed hours/days/weeks;
9. Other certifications required (e.g. Board certification, CPR training);
10. Vaccinations required;
11. Screenings (e.g. annual physical) required;
12. Years of experience required;
13. Educational level required; and
14. Special requirements (e.g. “must be able to lift more than 50 lbs”).

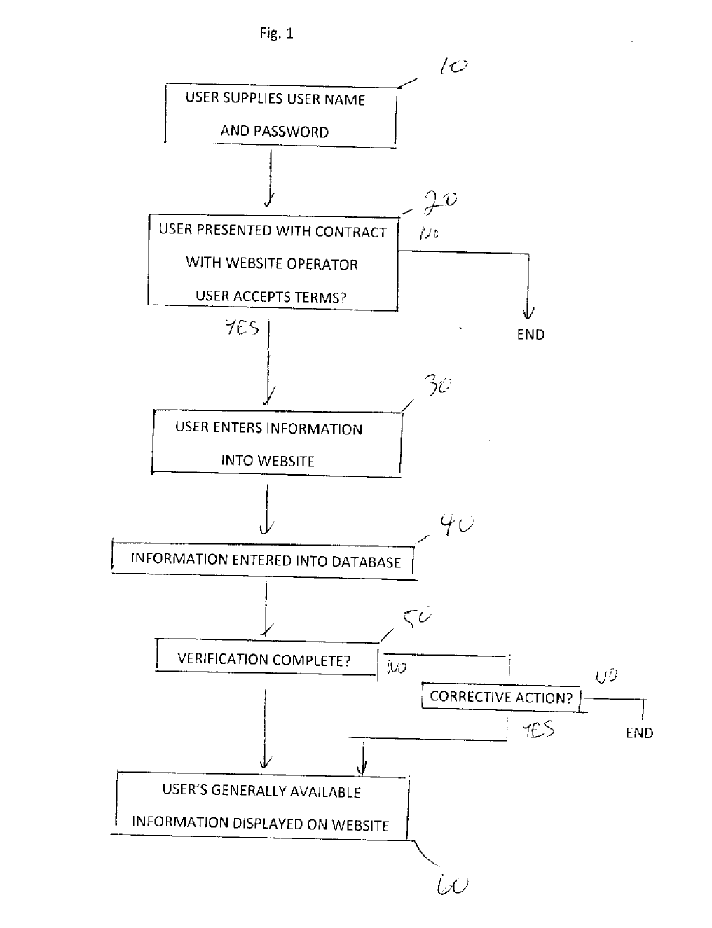

The information displayed has been provided by persons and firms that have registered with the website as described below. Once the member of the public has reviewed all the information displayed on the website, he or she may be motivated to use the website to seek work or to post a work assignment. In either case, the person is offered the opportunity to register with the website. As can be seen in FIG. 1, in step 10 the user supplies a user name and password by which he or she will register with (and subsequently log onto) the website. Thereafter, in step 20, user is presented with a contract establishing legal terms and conditions applicable to the user's relationship with the operator of the website (a “terms of service” contract). Such legal terms and conditions may e.g. specify the compensation that the registrant will pay to the website operator, and what will happen with the information the registrant submits to the website. If the user agrees to the terms of service by so indicating on the website, the user proceeds as explained below. If the user does not agree to the terms of service, the user is not permitted to continue and the process comes to an end.

Thereafter, in step 30, the user is prompted to enter information about him- or herself (if he or she seeks work) or about his firm and the work assignment (if the user seeks a service provider). Items of information are identified as “generally available”, “restricted”, or “for system administration only”, as follows:

### For Each Medical Professional

1. Full name—Restricted *;
2. Full company name—Restricted;
3. Tax information—System administration only;
4. Home address—Restricted;
5. Business address—Restricted;
6. Email address—Restricted *;
7. Home telephone—Restricted;
8. Business telephone—Restricted;
9. Background check (carried out by third party, medical professional initiates the check, pays the third party, and provides the report)-Restricted;
10. Citizenship, information regarding liability insurance and claims, license suspensions, etc.—Restricted;
11. Complete list of skills—Restricted;
12. Summary of skills—Generally available;
13. Highest degree achieved—Generally available;
14. A verification that the professional has an active and clear license for his/her discipline—Generally available **; and
15. License document or web reference to it—Restricted.

### For Each Posted Work Assignment

1. Full company name—Restricted **;
2. Company address—Restricted **;
3. EIN—System administration only **;
4. Company telephone, fax, and e-mail address—Restricted **, ***;
5. Name, telephone, email of contact person—Restricted ***;
6. Company marketing materials—Restricted;
7. Company website link—Restricted;
8. Video link embed—Restricted;
9. The title of the job—Generally available;
10. The discipline/license type required—Generally available;
11. The city and state where the job is located—Generally available;
12. The type (e.g. hospital, physician's office) of facility in which the work will be done—Generally available—Generally available;
13. The duration of the job—Generally available;
14. The desired start date—Generally available;
15. The job type (full-time, part-time, as-needed)—Generally available;
16. Minimum guaranteed hours/days/weeks—Generally available;
17. Information regarding maximum acceptable compensation, overtime, etc.—System administration only;
18. Other certifications required (e.g. Board certification, CPR training)—Generally available;
19. Vaccinations required—Generally available;
20. Screenings (e.g. annual physical) required—Generally available;
21. Years of experience required—Generally available;
22. Educational level required—Generally available; and
23. Special requirements (e.g. “must be able to lift more than 50 lbs”)—Generally available.
   *—Indicates an automatic computer-generated verification.
   **—Indicates a verification using an internet search carried out manually by the system operator.
   ***—Indicates a verification using a telephone call or email message carried out manually by the system operator.

It will be understood that the information requested by the website can be less than, more than, or different from that listed above. Once the information has been uploaded, it is saved and entered into a database maintained by the website operator (step 40).

In step 50, the operator of the website verifies the indicated information, i.e. confirms that the information is accurate. In certain instances, the verification can be carried out by computer, but some manual verification (i.e. some verification that requires a human operator) will usually be required. If the website operator cannot verify all the information that must be verified, the registrant is contacted and advised that no display of any of the registrant's information can occur until such verification has been carried out, and in the absence of such verification the registrant's information is discarded. But, if the website operator can verify all the information that requires verification, in step 60 the registrant's generally available information is displayed on the website along with the generally available information for all the other registrants. No restricted information is displayed. (The website system will generate a unique “User ID” number for each registered service provider and this User ID may be displayed together with the generally available information relating to that service provider. However, the display of the User ID number does not enable persons viewing the website to identify who the registered service provider is, thereby maintaining the non-display of the service provider's restricted information.)

Let it now be assumed that a registered service provider (e.g. a nurse) sees a work assignment that is posted on the website and that (based on the information that the employer has made generally available) is potentially of interest. The nurse knows that the posted assignment is genuine because the website operator has verified that the employer is not a personnel agency and that the work assignment actually exists. The nurse can then, via the website, send a bid to the employer by bidding on the work assignment, giving the employer the opportunity to decide whether to open it (step 70). The bid will contain the following information, which is input on the website:
1. The date on which the nurse proposes to start work; and
2. The applicable rate(s) of compensation for the nurse's work.

It will be understood that different work assignments may require bids to contain different information. For example, some work assignments may require a nurse to work a night shift and the employer may require the nurse's bid to include her requested compensation for working the night shift (“night shift differential”), while other work assignments may not require this.

The nurse is comfortable sending the bid to the employer because the website prevents the employer from seeing the nurse's restricted information, just as the website prevents the nurse from seeing the employer's restricted information; insofar as information is concerned, the parties are on an equal footing and neither has more information than the other.

The employer who receives the bid reviews the nurse's generally available information to see if the nurse is potentially suited for the advertised work assignment. And, the employer knows that the nurse does indeed have the necessary license(s)/credentials to do the necessary work because the website operator has already verified this.

The employer will not open the nurse's bid unless the employer believes that the nurse is an appropriate candidate for the work assignment, because opening a bid enables the nurse to view the employer's restricted information, just as it enables the employer to view the nurse's restricted information. Thus, in step 80, the employer decides whether to open the bid. If the employer does not open the bid, nothing happens. But, if the employer believes that the nurse is an appropriate candidate, the employer can open the nurse's bid.

Once the employer opens the nurse's bid, the employer's restricted information is automatically made available to the nurse and the nurse's restricted information is automatically made available to the employer (step 90). Just as before, each party has information parity with the other.

At this point, the employer makes a decision whether to accept, reject, or modify the nurse's bid (step 100). If the employer accepts the bid by so indicating on the website, the website generates a contract between the employer and the nurse (step 110). The contract is generated by merging legal terms and conditions in a stored contract template with the names, addresses, etc. of the parties as contained in the database and with the required bid terms that the parties have agreed upon. Each of the parties is then given the opportunity to accept this contract (step 120). If they both accept it by so indicating on the website (step 130) they create a binding contract between them. If at least one of them does not accept it (step 120) then the process comes to an end, as it does if the employer rejects the bid.

Alternatively, the employer may decide (step 140) to modify the bid terms that the nurse has proposed. On the website, the employer can counterpropose a new contract duration, a new start date, different rates of compensation, and a different number of minimum guaranteed work hours per pay period. At this point, it is the nurse who has the option of accepting, rejecting, or further modifying the terms counterproposed by the employer (steps 150 and 160). This process continues until the parties reach agreement or abandon negotiations. (It will be understood that negotiations can also take place via alternate routes, e.g. telephone or Skype. However, the agreed-upon terms must eventually be entered into the website in order to generate a contract between the employer and the service provider.)

Although in this example a single contract template is used for all the registrants on the site, it is alternatively possible to e.g. have one contract template applicable to work by physicians, another applicable to work by nurses, etc. Additionally, the information collected from employers and from service providers, and the information contained in bids, may be different. Furthermore, registrants may be permitted to provide more and different information than required by the website.

Although a preferred embodiment has been described above, the scope of the invention is limited only by the following claims:

1. A method for matching professional service providers with employers having work assignments, comprising:
a. establishing items of information required to be provided by the service providers and categorizing such items of information into
i. generally available provider information, said generally available provider information including professional credentials of the service provider, and
ii. restricted provider information, said restricted provider information including identity of the service provider;
b. establishing items of information to be required provided by the employers and categorizing such items of information into
i. generally available employer information, and
ii. restricted employer information, said restricted employer information including identity of the employer;
c. establishing a contract template appropriate for contractually engaging a professional service provider to perform a work assignment for an employer, said contract template having legal terms and conditions that cannot be changed by either the employer or the service provider and also having negotiable data items that can be supplied and modified by the employer and the service provider;
d. creating a database including information about
i. service providers who have provided all required items of information and whose credentials and identity have been verified, and
ii. employers who have provided all required items of information and whose identity has been verified;
e. initially making only generally available provider information provided by service providers in the database available to employers in the database;
f. initially making restricted provider information provided by service providers in the database unavailable to employers in the database;
g. initially making only generally available employer information provided by employers in the database available to service providers in the database;
h. initially making restricted employer information provided by employers in the database unavailable to service providers in the database;
i. directing a bid submitted by a service provider to an employer identified by that service provider by bidding on a work assignment posted by the employer, the bid including all required negotiable data items in the contract template;
j. allowing an employer to open a bid that has been directed to that employer and thereby
i. automatically making the restricted employer information of the employer available to the bidding service provider, and
ii. simultaneously with making such restricted employer information available to the bidding service provider, automatically making the restricted provider information of the bidding service provider available to the employer to which the bid was directed.

2. The method of claim 1, further comprising allowing the employer to modify the negotiable data items supplied by the service provider and allowing the service provider to modify the negotiable data items changed by the employer.

3. The method of claim 2, further comprising allowing a one of the service provider and the employer to agree to all negotiable data items supplied by or modified by the other of the service provider and the employer, thereby forming a binding contract between the service provider and the employer.

4. The method of claim 1, wherein the creating step includes the step of requiring each service provider and each employer to enter into an agreement with the party that performs the method.

5. The method of claim 1, wherein the generally available provider information includes a summary of the provider's skills.

6. The method of claim 1, wherein the generally available employer information includes information about the work assignment and its general location.

7. The method of claim 1, wherein the negotiable data items include the rate of compensation, the duration of the work assignment, and the start date of the work assignment.

8. The method of claim 1, wherein the verifications of step 1.d are at least partially carried out manually.

9. The method of claim 1, wherein the method is computerized and implemented on an Internet website and all generally available information is available to anyone who chooses to view the Internet website.

10. A method for implementation on an Internet website, the method matching professional service providers with employers having work assignments, comprising:
a. establishing items of information required to be provided by the service providers and categorizing such items of information into
i. generally available provider information, said generally available provider information including professional credentials of the service provider, and
ii. restricted provider information, said restricted provider information including identity of the service provider;
b. requiring the service provider to enter into an agreement with an owner of the website by indicating acceptance of the terms and conditions of the agreement on the website;
c. collecting all of said items of information from a service provider by allowing the service provider to enter said items of information on the website;
d. verifying the professional credentials and identity of the service provider;
e. establishing items of information to be required provided by the employers and categorizing such items of information into
i. generally available employer information, and
ii. restricted employer information, said restricted employer information including identity of the employer;
f. requiring the employer to enter into an agreement with an owner of the website by indicating acceptance of the terms and conditions of the agreement on the website;
g. collecting all of said items of information from an employer by allowing the employer to enter said items of information on the website;
h. verifying the identity of the employer;
i. establishing a contract template appropriate for contractually engaging a professional service provider to perform a work assignment for an employer, said contract template having legal terms and conditions that cannot be changed by either the employer or the service provider and also having negotiable data items that can be supplied and modified by the employer and the service provider;
j. compiling a database including information about
i. service providers who have provided all required items of information and whose credentials and identity have been verified, and
ii. employers who have provided all required items of information and whose identity has been verified;
k. displaying all generally available provider information and employer information on the website;
l. allowing a service provider to direct a bid to a selected employer by using the website to bid upon a work assignment posted by the employer and to specify all required negotiable data items in the contract template;
m. allowing an employer to open a bid that has been directed to that employer by using the website and thereby
i. automatically causing the restricted employer information of the employer to be displayed to the bidding service provider, and
ii. simultaneously therewith, automatically causing the restricted service provider information of the bidding service provider to be displayed to the employer;
n. allowing a service provider and an employer to negotiate by allowing each of them to change the negotiable data items by using the website; and
o. allowing a service provider and an employer to enter into a binding contract by allowing a one of them to agree to all negotiable data items as presented by or changed by another of them, such agreement being accomplished by using the website.

11. The method of claim 10, wherein the steps of 10.d and 10.h are performed manually.
